(19) United States
(12) Patent Application Publication
(10) Pub. No.: US 2008/0145624 A1
(43) Pub. Date: Jun. 19, 2008

(54) Printed, moldable films

(76) Inventors: Jan Weikard, Odenthal-Erberich (DE); Klaus Meyer, Dormagen (DE); Hans Braun, Grevenbroich (DE); Roland Kunzel, Leverkusen (DE); Erhard Luehmann, Bomlitz (DE); Diethelm Rappen, Rheinberg (DE); Nicolas Stoeckel, Koln (DE)

Correspondence Address: BAYER MATERIAL SCIENCE LLC, 100 BAYER ROAD, PITTSBURGH, PA, 15205, US

(21) Appl. No.: 11/978,463

(22) Filed: Oct. 29, 2007

(30) Foreign Application Priority Data
Oct. 31, 2006 (DE) 10 2006 051 897.7

(51) Int. Cl. B32B 33/00; B29C 59/16

(52) U.S. Cl. 428/195.1; 264/447

(57) ABSTRACT

The present invention relates to printed films, to a process for printing said films, to the curing of layers applied by printing processes, and to molded articles produced from said layers.

### CROSS-REFERENCE TO RELATED APPLICATIONS

The present application claims the right of priority under 35 U.S.C. §119 (a)-(d) of German Patent Application Number 10 2006 051 897.7, filed Oct. 31, 2006.

### BACKGROUND OF THE INVENTION

The present invention relates to films, to a process for printing said films, to the curing of layers applied by printing processes, and to molded articles produced from said layers.

Processes are known in which, firstly, a film of synthetic material is coated over a large area by means of standard lacquering processes such as blade coating, spraying or dipping, and the coating begins to dry so as to be virtually tack-free as a result of physical drying or partial curing. Where appropriate, after protecting the coated film by means of a further laminated or backed protective film, the film can then be molded at elevated temperatures. This concept offers great potential for the production of, for example, vehicle attachments, where the more elaborate step of lacquering three-dimensional structural members could be replaced by the simpler coating of a planar substrate.

As a general rule, good surface properties presuppose a high density of crosslinking of the coating. But high crosslinking densities result in thermosetting behavior with maximum possible degrees of stretching of just a few percent, so that the coating has a tendency towards cracking during the forming operation. This obvious conflict between requisite high density of crosslinking and high degree of stretching which is striven for can be solved by a variety of methods, for example, by the curing being implemented in two steps, before and after forming. This can be achieved, for example, by drying/curing in accordance with two different mechanisms.

EP-A 0 819 516 describes a process for lacquering an object during a forming operation by means of a moldable, radiation-curable lacquer film. A disadvantage in this case is that by reason of the low glass-transition temperature, the blocking resistance of the lacquered film prior to molding and postcuring does not obtain to a sufficient degree. This impairs the handling prior to final curing considerably. It also is a great disadvantage for industrial application, since such films cannot, for example, be rolled up, or can only be rolled up using protective films, since otherwise they bake together. In addition, except for the glass-transition temperature and the naming of polymer classes (“phosphazenes, urethanes, acrylates”) it cannot be inferred from this state of the art what nature the components of a lacquer system have to have in order to enable thermoplastic moldability and thermosetting behavior, in particular resistances to weathering and scratching after final curing. Besides, the achievable degrees of stretching are not mentioned.

WO 00/63015 likewise describes a coated moldable film that can be cured by means of radiation. By addition of polymeric components having a glass-transition temperature above 40° C., an improved blocking resistance prior to molding is obtained. Similar films are also described in WO 2005/080484, WO 2005/099943, WO 2005/118689, WO 2006/048109. In no case, however, is coating affected by means of printing processes.

In all the known processes the application of the coatings is effected by customary lacquering processes, which are not suitable for producing small surfaces and/or multicolor decorations and/or are uneconomical.

EP-A-0 688 839 describes high-temperature-resistant, flexible screen-printing inks based on a special polycarbonate binding agent. Such screen-printing inks are used, for example, for printing moldable films that can also be injection-backed. A corresponding process is taught by EP-A 0 691 201. By reason of deficient crosslinking, the coatings applied by means of such printing processes are inferior to conventional, crosslinked coatings with respect to chemical and mechanical resistance.

Summing up, it can be noted that a process for producing molded printed films is not known from the state of the art that satisfies the following prerequisites:

1) simple application by customary printing processes on a film or on a film composite;

2) thermal drying and, where appropriate, curing via a polyaddition mechanism that results in a non-blocking thermoplastic printed film which can be molded by appropriate tools; and

3) final curing by means of actinic radiation of the coating on the molded film that has been applied with the aid of printing processes, whereby resistance properties of the coating are obtained such as can also be achieved by conventional lacquering of already shaped objects.

The provision of a process of such a type is part of the object underlying the present invention.

### SUMMARY OF THE INVENTION

The invention therefore also provides a process for producing molded printed films, comprising

A) optionally printing a thermoplastic film with one or more color-imparting coating agents a) and subsequently drying and/or curing the coating agents a) to yield a coating a*), the coating agent a) and the drying/curing conditions being chosen such that the coating a*) is thermoplastic,

B) printing the thermoplastic film with at least one coating agent b) which contains constituents that are capable of being cured with actinic radiation,

C) drying and/or curing the coating agent b), without exposing the coating agent b) to actinic radiation, to yield a non-blocking and thermoplastic coating b*),

D) molding the coated thermoplastic film at an elevated temperature,

E) curing the coating b*) by irradiation with actinic radiation to yield a thermosetting layer, and

F) optionally backing the coated film with synthetic materials.

### DETAILED DESCRIPTION OF THE PREFERRED EMBODIMENTS

Steps E) and F) may optionally also be implemented in reverse order.

The invention also provides the molded films produced by the process according to the invention in steps A)-E) as well as the molded articles produced in steps A)-F).

### Step A

Besides general resistance requirements, the film to be employed in accordance with the invention must possess, above all, the necessary thermal mouldability. Suitable in principle, therefore, are thermoplastic polymers or thermoplastic materials such as ABS, AMMA, ASA, CA, CAB, EP, UF, CF, MF, MPF, PF, PAN, PA, PE, HDPE, LDPE, LLDPE, PC, PET, PMMA, PP, PS, SB, PUR, PVC, RF, SAN, PBT, PPE, POM, PP-EPDM and UP (short designations in accordance with DIN 7728T1) and also their mixtures; furthermore, composite films constructed from two or more layers of these synthetic materials. In general, the films to be employed in accordance with the invention may also contain reinforcing fibers or woven fabrics, provided that these do not impair or render impossible the desired thermoplastic deformation.

Particularly suitable are thermoplastic polyurethanes, polymethyl methacrylate (PMMA) and also modified variants of PMMA; furthermore, PC, ASA, PET, PP, PP-EPDM and ABS.

The film is preferably used in a thickness from 50 μm to 5000 μm, particularly preferably from 200 μm to 2000 μm. The polymer of the film may optionally contain additives and processing auxiliaries for the purpose of producing films, such as, for example, stabilizers, plasticizers, fillers such as fibers and dyestuffs. The side of the film designated for coating and also the other side of the film may be smooth or may exhibit a surface structure, a smooth surface of the side to be coated being preferred.

On the reverse of the film, i.e. on the surface on which the coating agent is not applied, a thermally moldable layer of adhesive may optionally have been applied. Hot-melt adhesives or radiation-curing adhesives are preferably suitable for this purpose, depending on the manner of proceeding. In addition, a protective film that is likewise thermally moldable may also be applied on the surface of the adhesive layer. Moreover, it is possible to endow the film on the reverse with backing materials such as woven fabrics which, however, have to be moldable to the desired degree.

Coating agents a) are, for example, printing-inks which in the dried/cured state a*) are thermoplastic and therefore can be molded with the film in the course of process step D) without formation of cracks or deterioration of the optical properties. Suitable, therefore, as binding agents for the printing-ink are nitrocellulose, in combination with plasticizers, thermoplastic polyurethanes, thermoplastic polyesters, thermoplastic polycarbonates, thermoplastic poly(meth)acrylates. In the choice of the suitable binding agent, the glass-transition temperature thereof should be chosen such that it lies above the glass-transition temperature of the film or of the coated layer of the composite film, but is nevertheless sufficiently low that molding in step D) is possible without difficulty. In the course of a simple thermoforming, the glass-transition temperature of the film and the coating a*) must lie below the temperature set in the tool in the course of thermoforming. The selection of the binding agent for the coating agent a) for the desired molding process can therefore be ascertained by a person skilled in the art in simple experiments.

Suitable coating agents a) may be present in solvent-containing form, in solvent-free form or in aqueous form. In addition to binding agents, further constituents that are customary for printing-inks may be included—for example, dyestuffs, effect-creating pigments, fillers, additives, catalysts, initiators and/or stabilizers. Preferably, the coating agent a) contains at least one dyestuff.

For the purpose of applying the coating agent a) onto the film, the film may be pretreated where appropriate. Customary pretreatments include cleaning with solvents or with aqueous cleaning agents, activation by means of flame treatment, UV irradiation, corona treatment, plasma treatment or treatment with ionized gas such as, for example, ionized air, in order to reduce incursion of dust.

Particularly suitable printing-inks are described in EP-A 0 688 839, the contents of which are hereby incorporated by reference.

Particularly suitable printing-inks are available from, for example, Pröll K G, Weiβenburg, D E under the name Noriphan® HTR.

Suitable printing processes for the application of the coating agents a) are known; in principle, all printing processes are suitable, such as relief printing, gravure printing, flexographic printing, offset printing, screen printing, tampon printing, ink-jet printing and laser printing. Screen printing and laser printing are preferred; screen printing is particularly preferred.

Subsequent to the printing, the coating agent a) is dried and/or cured by customary processes, in which connection a pure drying without curing (by chemical crosslinking) is preferred.

For the purpose of generating polychromatically printed films, it is possible to apply various printing-inks a₁)-aₙ) simultaneously, for example by ink-jet printing or laser printing, or in succession, for example by screen printing, and to dry/cure them.

### Step B

For the purpose of applying the coating b) in process step B), the film, which, where appropriate, has been printed after A), may firstly be pretreated. Customary pretreatments include cleaning with solvents or with aqueous cleaning agents, activation by means of flame treatment, UV irradiation, corona treatment, plasma treatment or treatment with ionized gas such as, for example, ionized air, in order to reduce incursion of dust.

The film is then printed with at least one coating agent b) which contains constituents that are capable of being cured with actinic radiation. The coating agent b) is such that it is dried, or dried and cured, in step C) to yield a non-blocking coating b*). The constituents of the coating agent b), in particular the binding agent that is included, must therefore be so chosen from the viewpoint of their influence on the glass-transition temperature of the coating b*) that is dried, or dried and cured, in step C) that glass-transition temperature is at least 35° C., preferably 40° C. or more. In this connection it holds that the higher the glass-transition temperature of b*), the better the blocking resistance. At the same time, in order to guarantee good mouldability in step D) the glass-transition temperature of b*) should not be significantly higher—that is to say, at most 10° C. higher, preferably only 5° C. higher—than the glass-transition temperature of the film or that of the uppermost layer of the composite film.

The term ‘drying’—also designated as physical curing—is understood by a person skilled in the art to mean curing accompanied by release of the solvent at room temperature or preferably at elevated temperature. In this connection, the molecular weight and the chemical nature of the molecules of the binding agent remain unchanged, but a physical crosslinking of the chain molecules with one another occurs, for example as a result of looping or hydrogen bonding, so that a dry, non-blocking lacquer surface can be obtained. In the case of dispersion lacquers or dispersion-based coating substances, the physical curing is effected by coalescence of the coating-agent particles, whereby likewise at room temperature or preferably at elevated temperature the solvent, in most cases water, is released and the particles of the dispersion merge to form a coating that, with complete release of the solvent, is likewise able to form a dry, non-blocking lacquer surface.

Suitable drying, aqueous coating agents b) contain at least one constituent by way of a binding agent that is capable of being cured with actinic radiation. Suitable binding agents are UV-curing polyurethane dispersions, UV-curing polyacrylate dispersions and also combinations thereof with one another and with UV-curing monomers; suitable furthermore are combinations of UV-curing polyurethane dispersions with polyacrylate dispersions.

Suitable commercial binding agents are available, for example, under the name Lux® from Alberdingk & Boley GmbH, Krefeld, DE, in particular the products Lux 1613, 241, 285, 331, 460, 480; furthermore, Laromer® from BASF AG, Ludwigshafen, DE, in particular the products LR 8949, 8983, 9005; furthermore, Bayhydrol® UV from Bayer MaterialScience AG, Leverkusen, DE, in particular Bayhydrol® UV 2282, VP LS 2317, VP LS 2280 and XP 2629; furthermore, Ucecoat® from Cytec Surface Specialities SA/NV, Brussels, BE, in particular Ucecoat® 7571, 7770, 7772, 7773, 7825 and 7849.

The production of UV-curing dispersions with physical flashing-off prior to a UV curing is described in patent applications EP-A 0 753 531 and EP-A 0 942 022, for example.

Suitable solvent-containing coating agents b) contain binding agents that are capable of being cured with actinic radiation. Suitable as constituents of the binding agents are, for example, urethane (meth)acrylates, polyester (meth)acrylates, epoxy (meth)acrylates and (meth)acrylated polymers such as polyacrylates. Suitable products have the previously described influence on the glass-transition temperature. Urethane (meth)acrylates are preferred.

The production of suitable urethane (meth)acrylates having high glass-transition temperatures is described in detail in patent applications EP-A 1 448 735 and EP-A 1 541 649, for example. EP-A 1 448 735 describes the production of urethane (meth)acrylates having suitable glass-transition temperatures and low melt viscosity, and their use in powder lacquers. These products may be employed, dissolved in suitable organic solvents, as binding agents for suitable coating agents b). Further products are the urethane acrylates named in WO 2005/080484, WO 2005/099943, WO 2005/118689, WO 2006/048109.

Suitable polyester (meth)acrylates are known. In particular, products that are commercially available as binding agents for UV-curing powder lacquers are suitable, dissolved in organic solvents; for example, Uvecoat® 2300 and 3003 from Cytec Surface Specialities BV/NV, Brussels, BE.

Suitable (meth)acrylated polymers of vinylic monomers are likewise known. Particularly suitable are products having a glass-transition temperature above 40° C. For example, Ebecryl® 1200 from Cytec Surface Specialities BV/NV, Brussels, BE.

Besides the pure physical drying, in step C) the coating b) may preferably be physically dried and additionally cured to yield b*).

The term ‘chemical curing’ is understood by a person skilled in the art to mean curing by chemical crosslinking at room temperature or at elevated temperature of molecules contained in the coating agent. Curing is preferably effected by polyaddition.

If, besides the physical drying, the coating b) is additionally cured chemically, care has to be taken to ensure that the density of crosslinking in b*) is not too high, since otherwise the mouldability of b*) in step D) is too slight. It is therefore preferred to build up substantially high-molecular chains as a result of the chemical curing. Correspondingly, the components and/or their proportions in b) should be so chosen that in the sense of the deformation D) only a slight crosslinking takes place in the course of the curing C).

The chemically curable coating agent b) may find application both dissolved 100% in solid or liquid form in organic solvents and dissolved in aqueous phase and/or in emulsified form.

The coating agent b) therefore contains:
1) one or more compounds that contain at least one chemical function I) suitable for polyaddition with component 2), such compounds including
   1.1) compounds containing no ethylenically unsaturated double bonds and/or
   1.2) compounds containing ethylenically unsaturated double bonds
2) one or more compounds that contain at least one chemical function II) suitable for polyaddition with component 1) and different from I), such compounds including
   2.1) compounds containing no ethylenically unsaturated double bonds and/or
   2.2) compounds containing ethylenically unsaturated double bonds and optionally:
3) ethylenically unsaturated compounds that exhibit no chemical functions suitable for polyaddition
4) photoinitiators
5) coloring agents, pigments, additives such as stabilizers, catalysts and other auxiliary substances and additives as well as solvents
6) non-functional polymers and/or fillers,
   with at least one of components 1-3) exhibiting ethylenically unsaturated groups.

The content of ethylenically unsaturated groups has significant influence on the achievable resistance properties of the coating that has been cured with actinic radiation. It is therefore preferred to employ at least a content of 0.5 mol of ethylenically unsaturated groups per kg of solids content of the coating agent. Particularly resistant systems contain at least 1.0 mol, in particular at least 1.5 mol, per kg.

Suitable chemical functions I) and II) for the polyaddition are, in principle, all the functions that are customarily used in coating technology. Particularly suitable are isocyanate hydroxyl, thiol, amine and/or urethane, carboxylate epoxide, melamine hydroxyl, and carbamate hydroxyl. Suitable furthermore are carbodiimides and/or polyaziridines together with appropriately reactive functions. By way of function I, isocyanates are quite particularly preferred, and, by way of function II, hydroxyl, primary and/or secondary amines and also aspartate are preferred.

By way of isocyanates I), use is made of aromatic, araliphatic, aliphatic and cycloaliphatic diisocyanates or polyisocyanates. Mixtures of such diisocyanates or polyisocyanates may also be employed. Examples of suitable diisocyanates or polyisocyanates are butylene diisocyanate, hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes and mixtures thereof having an arbitrary isomer content, isocyanatomethyl-1,8-octane diisocyanate, 1,4-cyclohexylene diisocyanate, the isomeric cyclohexane-dimethylene diisocyanates, 1,4-phenylene diisocyanate, 2,4- and/or 2,6-toluylene diisocyanate, 1,5-naphthylene diisocyanate, 2,4′- or 4,4′-diphenylmethane diisocyanate, triphenylmethane-4,4′,4″-triisocyanate or derivatives thereof having urethane, urea, carbodiimide, acrylic-urea, isocyanurate, allophanate, biuret, oxadiazinetrione, uretdione, iminooxadiazinedione structure and mixtures of the same. Preferred are polyisocyanates based on oligomerised and/or derivatised diisocyanates that have been freed of excess diisocyanate by means of suitable processes, in particular those of hexamethylene diisocyanate, isophorone diisocyanate and of the isomeric bis(4,4′-isocyanatocyclohexyl)methanes and also mixtures thereof. Preferred are the oligomeric isocyanurates, uretdiones, allophanates and iminooxadiazinediones of HDI, of IPDI and/or of the isomeric bis(4,4′-isocyanatocyclohexyl)methanes and also mixtures thereof. Particularly preferred are the oligomeric isocyanurates, uretdiones and allophanates of IPDI and also the oligomeric isocyanurates of the isomeric bis(4,4′-isocyanatocyclohexyl)methanes.

It is also possible to use the aforementioned isocyanates I) partially converted with isocyanate-reactive ethylenically unsaturated compounds. Preferably employed for this purpose are α,β-unsaturated carboxylic-acid derivatives such as acrylates, methacrylates, maleates, fumarates, maleimides, acrylamides and also vinyl ethers, propenyl ethers, allyl ethers and compounds containing dicyclopentadienyl units that exhibit at least one group that is reactive in relation to isocyanates; in particularly preferred manner these are acrylates and methacrylates with at least one isocyanate-reactive group. By way of hydroxy-functional acrylates or methacrylates, compounds such as 2-hydroxyethyl (meth)acrylate, polyethylene-oxide mono(meth)acrylates, polypropylene-oxide mono(meth)acrylates, polyalkylene-oxide mono(meth)acrylates, poly(ε-caprolactone) mono(meth)acrylates, such as, for example, Tone® M100 (Dow, USA), 2-hydroxypropyl (meth)acrylate, 4-hydroxybutyl (meth)acrylate, 3-hydroxy-2,2-dimethylpropyl (meth)acrylate, the hydroxy-functional mono(meth)acrylates, di(meth)acrylates or tetra(meth)acrylates of polyhydric alcohols, such as trimethylolpropane, glycerin, pentaerythritol, dipentaerythritol, ethoxylated, propoxylated or alkoxylated trimethylolpropane, glycerin, pentaerythritol, dipentaerythritol or technical mixtures thereof enter into consideration, for example. Also suitable are isocyanate-reactive oligomeric or polymeric compounds exhibiting unsaturated acrylate groups and/or methacrylate groups, on their own or in combination with the aforementioned monomeric compounds.

Conversion of the isocyanates with the isocyanate-reactive components may be effected in accordance with known processes, accompanied by urethanisation and/or allophanatisation.

By way of compounds of component 1.1), use may be made of all the aforementioned diisocyanates or polyisocyanates 1), individually or in arbitrary mixtures, that exhibit no ethylenically unsaturated functions.

By way of compounds of component 1.2), use may be made of all the aforementioned compounds 1), individually or in arbitrary mixtures, that exhibit at least one isocyanate group and additionally exhibit at least one ethylenically unsaturated function that reacts with ethylenically unsaturated compounds accompanied by polymerization under the influence of actinic radiation.

For the purpose of achieving a good physical drying, besides the curing in step C), it is preferred that component 1) contains a high proportion of aromatic and/or cycloaliphatic structural units, in particularly preferred manner a high proportion of cycloaliphatic structural units, this being achievable, in particular, through choice of the appropriate isocyanate compounds.

Isocyanate-reactive compounds 2) are monomeric, oligomeric or polymeric compounds and also mixtures of one or more of these compounds.

Suitable compounds of component 2) are low-molecular short-chain—i.e. containing 2 to 20 carbon atoms—aliphatic, araliphatic or cycloaliphatic diols, triols and/or higher polyols. Examples of diols are ethylene glycol, diethylene glycol, triethylene glycol, tetraethylene glycol, dipropylene glycol, tripropylene glycol, 1,2-propanediol, 1,3-propanediol, 1,4-butanediol, neopentyl glycol, 2-ethyl-2-butylpropanediol, trimethylpentanediol, positionally isomeric diethyloctanediols, 1,3-butyleneglycol, cyclohexanediol, 1,4-cyclohexanedimethanol, 1,6-hexanediol, 1,2- and 1,4-cyclohexanediol, hydrated bisphenol A (2,2-bis(4-hydroxycyclohexyl)propane), 2,2-dimethyl-3-hydroxypriopionic acid-2,2-dimethyl-3-hydroxypropyl ester). Examples of suitable triols are trimethylolethane, trimethylolpropane or glycerin. Suitable alcohols of higher functionality are ditrimethylolpropane, pentaerythritol, dipentaerythritol or sorbitol. Aliphatic diols are preferred; cycloaliphatic diols are quite particularly preferred.

Also suitable are higher-molecular aliphatic and cycloaliphatic polyols such as polyester polyols, polyether polyols, polycarbonate polyols, hydroxy-functional acrylic resins, hydroxy-functional polyurethanes, hydroxy-functional epoxy resins or corresponding hybrids (cf. Römpp Lexikon Chemie, pp 465-466, 10th Edn. 1998, Georg-Thieme-Verlag, Stuttgart). Preferred are (cyclo)aliphatic polyester polyols and/or (cyclo)aliphatic polycarbonate polyols; quite particularly preferred are polyester polyols and/or polycarbonate polyols that contain aliphatic diols in branched linear form.

Moreover, by way of compounds of component 2), use may be made of all compounds, individually or in arbitrary mixtures, that exhibit at least one group that is reactive in relation to isocyanates and at least one unsaturated function that reacts with ethylenically unsaturated compounds accompanied by polymerization under the influence of actinic radiation.

Preferably employed are α,β-unsaturated carboxylic-acid derivatives such as acrylates, methacrylates, maleates, fumarates, maleimides, acrylamides, and also vinyl ethers, propylene ethers, allyl ethers and compounds containing dicyclopentadienyl units that exhibit at least one group that is reactive in relation to isocyanates; in particularly preferred manner these are acrylates and methacrylates with at least one isocyanate-reactive group.

By way of hydroxy-functional acrylates or methacrylates, compounds such as 2-hydroxyethyl (meth)acrylate, polyethylene-oxide mono(meth)acrylates, polypropylene-oxide mono(meth)acrylates, polyalkylene-oxide mono(meth)acrylates, poly(c-caprolactone) mono(meth)acrylates, such as, for example, Tone® M100 (Dow, Schwalbach, DE), 2-hydroxypropyl (meth)acrylate, 4-hydroxybutyl (meth)acrylate, 3-hydroxy-2,2-dimethylpropyl (meth)acrylate, the hydroxy-functional monoacrylates, diacrylates or tetraacrylates of polyhydric alcohols, such as trimethylolpropane, glycerin, pentaerythritol, dipentaerythritol, ethoxylated, propoxylated or alkoxylated trimethylolpropane, glycerin, pentaerythritol, dipentaerythritol or technical mixtures thereof enter into consideration, for example,

Also suitable are isocyanate-reactive oligomeric or polymeric compounds exhibiting unsaturated acrylate groups and/or methacrylate groups, on their own or in combination with the aforementioned monomeric compounds.

The production of polyester acrylates is described in DE-A 40 40 290 (p 3, line 25-p 6, line 24), DE-A-33 16 592 (p 5, line 14-p 11, line 30) and P. K. T. Oldring (Ed.), Chemistry & Technology of UV & EB Formulations for Coatings, Inks & Paints, Vol. 2, 1991, SITA Technology, London, pp 123-135.

Use may likewise be made of the hydroxyl-group-containing epoxy (meth)acrylates known as such with OH contents from 20 mg KOH/g to 300 mg KOH/g, or of hydroxyl-group-containing polyurethane (meth)acrylates with OH contents from 20 mg KOH/g to 300 mg KOH/g, or of acrylated polyacrylates with OH contents from 20 mg KOH/g to 300 mg KOH/g, and also mixtures thereof with one another and mixtures with hydroxyl-group-containing unsaturated polyesters and also mixtures with polyester (meth)acrylates or mixtures of hydroxyl-group-containing unsaturated polyesters with polyester (meth)acrylates. Such compounds are likewise described in P. K. T. Oldring (Ed.), Chemistry & Technology of UV & EB Formulations for Coatings, Inks & Paints, Vol. 2, 1991, SITA Technology, London, pp 37-56. Polyester acrylates with defined hydroxy functionality are preferred.

Hydroxyl-group-containing epoxy (meth)acrylates are based, in particular, on conversion products of acrylic acid and/or methacrylic acid with epoxides (glycidyl compounds) of monomeric, oligomeric or polymeric bisphenol A, bisphenol F, hexanediol and/or butanediol or the ethoxylated and/or propoxylated derivatives thereof. Preferred, moreover, are epoxy acrylates with defined functionality such as arise from the conversion of a—where appropriate—unsaturated di-acid such as fumaric acid, maleic acid, hexahydrophthalic acid or adipic acid and glycidyl (meth)acrylate. Aliphatic epoxy acrylates are particularly preferred. Acrylated polyacrylates may be produced by, for example, conversion of glycidyl-functional polyacrylates with (meth)acrylic acid.

By way of compounds of component 2.1), use may be made of all the aforementioned isocyanate-reactive compounds 2), individually or in arbitrary mixtures, that exhibit no ethylenically unsaturated functions.

By way of compounds of component 2.2), use may be made of all the aforementioned compounds 2), individually or in arbitrary mixtures, that exhibit at least one isocyanate-reactive group and additionally exhibit at least one ethylenically unsaturated function that reacts with ethylenically unsaturated compounds accompanied by polymerization under the influence of actinic radiation.

By way of optional component 3), use may be made of the aforementioned compounds that may find application in the case of purely physically drying coating agents b). In a subsidiary amount—i.e. only in such amounts that do not influence the blocking resistance after the drying C) too much—use may also be made of other monomeric or polymeric compounds that carry at least one functional group, that react with ethylenically unsaturated compounds accompanied by polymerization as a result of influence of actinic radiation, and that exhibit neither isocyanate groups nor isocyanate-reactive groups.

Suitable are α,β-unsaturated carboxylic-acid derivatives such as acrylates, methacrylates, maleates, fumarates, maleimides, acrylamides; furthermore, vinyl ethers, propenyl ethers, allyl ethers and compounds containing dicyclopentadienyl units. Vinyl ethers, acrylates and methacrylates are preferred; acrylates are particularly preferred. Examples contain the reactive thinners known in the technology of radiation curing (cf. Römpp Lexikon Chemie, p 491, 10th Edn. 1998, Georg-Thieme-Verlag, Stuttgart) or the binding agents known in the technology of radiation curing, such as polyether acrylates, polyester acrylates, urethane acrylates, epoxy acrylates, melamine acrylates, silicone acrylates, polycarbonate acrylates and acrylated polyacrylates.

Suitable esters are customarily obtained by esterification of alcohols with 2 to 20 carbon atoms, preferably of polyhydric alcohols with 2 to 20 carbon atoms, with unsaturated acids or unsaturated acid chlorides, preferably acrylic acid and derivatives thereof. To this end, the methods of esterification known to a person skilled in the art may be employed.

Suitable alcohol components in connection with the esterification are monohydric alcohols such as the isomeric butanediols, pentanediols, hexanediols, heptanediols, octanediols, nonanediols and decanediols; furthermore, cycloaliphatic alcohols such as isobornol, cyclohexanol and alkylated cyclohexanols, dicyclopentanol, arylaliphatic alcohols such as phenoxyethanol and nonylphenylethanol, and also tetrahydrofurfuryl alcohols. Also suitable are dihydric alcohols such as ethylene glycol, propanediol-1,2, propanediol-1,3, diethylene glycol, dipropylene glycol, the isomeric butanediols, neopentyl glycol, hexanediol-1,6, 2-ethylhexanediol, 1,4-cyclohexanediol, 1,4-cyclohexanedimethanol and tripropylene glycol. Suitable polyhydric alcohols are glycerin, trimethylolpropane, ditrimethylolpropane, pentaerythritol or dipentaerythritol. Preferred are diols and polyhydric alcohols; particularly preferred are glycerin, trimethylolpropane, pentaerythritol, dipentaerythritol and 1,4-cyclohexanedimethanol.

Photoinitiators 4) are initiators that are capable of being activated by actinic radiation and that trigger a radical polymerization of the corresponding polymerizable groups. Photoinitiators are commercially marketed compounds, known as such, in which a distinction is made between unimolecular (type I) and bimolecular (type II) initiators. Type-I systems are, for example, aromatic ketone compounds, for example benzophenones in combination with tertiary amines, alkylbenzophenones, 4,4′-bis(dimethylamino)benzophenone (Michler's ketone), anthrone and halogenated benzophenones or mixtures of the stated types. Suitable furthermore are (type-II) initiators such as benzoin and its derivatives, benzil ketals, acylphosphine oxides, for example 2,4,6-trimethylbenzoyldiphenylphosphine oxide, bisacylphophine oxides, phenylglyoxylic esters, camphorquinone, α-aminoalkylphenones, α,α-dialkoxyacetophenones and α-hydroxyalkylphenones. It can also be advantageous to employ mixtures of these compounds. Depending on the radiation source that is used for the purpose of curing, the type and concentration of photoinitiator have to be adapted in a manner known to a person skilled in the art. Further particulars are described in, for example, P. K. T. Oldring (Ed.), Chemistry & Technology of UV & EB Formulations for Coatings, Inks & Paints, Vol. 3, 1991, SITA Technology, London, pp 61-328.

By way of component 5), additives and/or auxiliaries and/or solvents may be included that are customary in the technology of lacquers, paints, printing-inks, sealants and adhesives.

In particular, these are stabilizers, light stabilizers such as UV absorbers and sterically hindered amines (HALS); furthermore, anti-oxidants and also lacquer auxiliaries, for example anti-settling agents, defoaming and/or wetting agents, flow-control agents, plasticizers, catalysts, auxiliary solvents and/or thickeners and also pigments, dyestuffs and/or flatting agents. The use of light stabilizers and the different types are described in exemplary manner in A. Valet, Lichtschutzmittel für Lacke, Vincentz Verlag, Hannover, 1996.

Suitable solvents are water and/or other standard solvents from printing technology, matched to the binding agents that are used and also to the printing process. Examples are acetone, ethyl acetate, butyl acetate, methoxypropyl acetate, glycols, water, xylene or solvent naphtha produced by Exxon-Chemie in the form of a solvent containing aromatic compounds, and also mixtures of the stated solvents.

By way of component 6), non-functional polymers and fillers for adjusting the mechanical and optical properties may be included. Suitable for this purpose are all polymers and fillers that are compatible and miscible with the coating agent. The compounds of component 6) may be employed both as bulk material and in the form of particles with average diameters within the range between one and 10,000 nanometers, preferably within the range from one to 500 nanometers, particularly preferably within the range from two to 200 nanometers.

By way of polymeric added substances, polymers such as, for example, polyacrylates, polycarbonates, polyurethanes, polyolefins, polyethers, polyesters, polyamides and polyureas enter into consideration.

By way of fillers, use may be made of mineral fillers, glass fibers and/or metallic fillers such as find application in standard procedures for so-called metallic lacquer coatings.

Suitable printing processes for the application of b) are known; in principle, all printing processes are suitable, such as relief printing, gravure printing, flexographic printing, offset printing, screen printing, tampon printing, digital printing such as ink-jet printing and laser printing. Screen printing and laser printing are preferred; screen printing is particularly preferred. The printing-ink b) can be adapted, depending on the printing process, by addition of solvents or by selection of appropriate additives for the printing process by procedures known as such.

The printing process itself presents no special methodical features, except that the printing-ink has to be protected against incidence of intense radiation (light, UV light) that is able to trigger a polymerization of the ethylenically unsaturated groups.

The application of the coating b) by a printing process offers the particular advantage that the film does not necessarily have to be printed over its full surface area, but only at the points at which the coating is desired in accordance with the later use.

Depending on the size of the film and the size of the desired printed image, it is possible to apply several printed images—pieces obtainable from one sheet—in parallel onto a print format and to process them further as appropriate.

### Step C) Drying/Curing

After the printing, solvent and/or water that is present is removed by standard methods. To this end, working takes place, in particular, at elevated temperatures in furnaces and with moving air (convection furnaces, jet dryers) and also thermal radiation (IR, NIR). Careful attention has to be paid to ensure that no polymerization (crosslinking) of the ethylenically unsaturated groups in b) is triggered as a result of the elevated temperature and/or the thermal radiation, since this impairs the mouldability. Moreover, the maximum temperature attained should be chosen to be so low that the film or composite film is not deformed in uncontrolled manner.

After the drying/curing step the printed film may, where appropriate, be rolled up without conglutination of the coating b*) to the reverse of the substrate film occurring. But it is also possible to cut the coated film to size and to convey the cut-to-size pieces, individually or in the form of a stack, to a stage for further processing.

### Step D) Molding

The printed film is brought into the desired final shape by thermal molding. This can be effected in accordance with standard processes such as thermoforming, vacuum thermoforming, compression molding, blow forming (see Lechner (Ed.), Makromolekulare Chemie, p 384 ff., Verlag Birkenhäuser, Basel, 1993) and also—preferably—in accordance with high-pressure molding processes such as are described in exemplary manner in EP-A 0 371 425. In the latter, molding is effected under relatively high pressures above 20 bar, preferably above 50 bar. The pressure to be applied is determined, in particular, by the thickness of the film to be molded and by the temperature, and also by the film material that is used; where appropriate, it should be ascertained in simple preliminary tests.

In the case of the high-pressure molding process it is particularly advantageous that working is able to proceed below the softening-temperature of the film material, preferably at least 20° C., particularly preferably at least 30° C., below the softening-temperature. This ‘cold’ molding has the advantage that use can be made of thinner films, which result in more exact shaping. A further advantage is constituted by shorter cycle-times and also a lower thermal loading of the coating b*).

Step E) Curing with Radiation

After the molding step, the coating b*) of the film is finally cured by irradiation with actinic radiation.

The term ‘curing with actinic radiation’ is understood to mean the radical polymerization of ethylenically unsaturated carbon-carbon double bonds by means of initiator radicals which are released, for example from the photoinitiators described above, as a result of irradiation with actinic radiation.

The radiation curing is preferably effected by influence of high-energy radiation—that is to say, UV radiation or daylight, for example light with a wavelength of 200 nm to 750 nm—or by irradiating with high-energy electrons (electron radiation, 90 keV to 300 keV). Medium-pressure or high-pressure mercury-vapor lamps, for example, serve as radiation sources for light or UV light, in which case the mercury vapor may be modified by doping with other elements such as gallium or iron. Lasers, pulsed lamps (known as UV flashlight radiation sources), halogen lamps or excimer radiation sources may likewise be employed. The radiation sources may have been installed immovably, so that the material to be irradiated is moved past the radiation source by means of a mechanical apparatus, or the radiation sources may be mobile, and the material to be irradiated does not change its location in the course of curing. The radiation dose that is customarily sufficient for crosslinking in the case of UV curing lies within the range from 80 mJ/cm² to 5000 mJ/cm².

The irradiation may, where appropriate, also be implemented subject to exclusion of oxygen, for example under inert-gas atmosphere or under oxygen-reduced atmosphere. Preferably suitable as inert gases are nitrogen, carbon dioxide, noble gases or combustion gases. Furthermore, irradiation may be effected by the coating being covered with media that are transparent to the radiation. Examples of such media are, for example, films of synthetic material, glass, or liquids such as water.

Depending on the radiation dose and on the conditions of curing, the type and concentration of the initiator that is used where appropriate should be varied or optimized in a manner known to a person skilled in the art or by means of tentative preliminary tests. For the purpose of curing the molded films, it is particularly advantageous to implement the curing with several radiation sources, the arrangement of which should be so chosen that each point of the coating receives, as far as possible, the dose and intensity of radiation that is optimal for curing. In particular, non-irradiated regions (shadow zones) should be avoided.

Moreover, depending on the film that is employed, it may be advantageous to choose the conditions of irradiation so that the thermal loading of the film does not become too great. In particular, thin films and also films consisting of materials having a low glass-transition temperature have a tendency towards uncontrolled deformation if a certain temperature is exceeded as a result of the irradiation. In these cases it is advantageous to allow as little as possible infrared radiation to act on the substrate, by means of suitable filters or by virtue of the design of the radiation sources. Moreover, uncontrolled deformation can be counteracted by reduction of the appropriate radiation dose. In this connection, however, care should be taken to ensure that a defined dose and intensity of the irradiation are necessary for a polymerization that is as complete as possible. In these cases it is particularly advantageous to cure under inert or oxygen-reduced conditions, since in the case of reduction of the oxygen content in the atmosphere above b*) the dose required for curing diminishes.

In particularly preferred manner, mercury radiation sources in fixed units are employed for the purpose of curing. Photoinitiators are then employed in concentrations from 0.1 wt. % to 10 wt. %, in particularly preferred manner 0.2 wt. % to 3.0 wt. %, relative to the solid matter of the coating. For the purpose of curing these coatings, use is preferably made of a dose from 500 mJ/cm² to 4000 mJ/cm², measured in the wavelength range from 200 nm to 600 nm.

The resulting printed, molded film displays very good resistances to solvent, to coloring liquids such as are to be found in the home, and also good scratch resistance and abrasion resistance. Overall, it is superior to the properties of non-crosslinked printed films such as can be obtained, for example, by printing with screen-printing inks in accordance with EP-A 0 668 839.

### Step F: Injection-Backing, Foam-Backing

The molded coated film may be modified before or after the final curing by injection-backing or even by foam-backing with, where appropriate, filled polymers such as thermoplastics or even reactive polymers such as two-component polyurethane systems. In this connection, where appropriate an adhesive layer may be employed by way of adhesion-promoter. To this end, use is made of suitable tools known as such.

The films produced by the process according to the invention in steps A)-E) and also the molded articles produced by the process according to the invention in steps A)-F) are valuable materials for producing utility articles. The invention therefore also provides the use of the film and also of the molded articles in the production of vehicle attachments, of synthetic-material parts such as shields for the construction of (the interior of) vehicles and/or for the construction of (the interior of) aircraft, for furniture manufacture, electronic appliances, communications equipment, housings and decorative objects. The invention therefore also provides the utility articles that are produced using the film or the molded articles.

### EXAMPLES

Acid value: indication in mg KOH/g of sample, titration with 0.1 mol/l NaOH solution against bromothymol blue (ethanolic solution), change in color from yellow via green to blue, basis DIN 3682.

Hydroxyl value: indication in mg KOH/g of sample, titration with 0.1 mol/l meth. KOH solution after cold acetylation with acetic anhydride, subject to catalysis by dimethylaminopyridine, basis DIN 53240.

Isocyanate content: indication in %, back titration with 0.1 mol/l hydrochloric acid after reaction with butylamine, basis DIN EN ISO 11909.

Gel permeation chromatography (GPC): eluting agent THF, RI detection, integration after calibration with polystyrene standards.

Viscosities: rotational viscometer (Haake, type VT 550), measurements at 23° C. and with rate of shear—unless noted otherwise—D 1/40 s⁻¹.

Unless noted otherwise, % indications are in wt. %.

### Components of a Coating Agent

### Example 1

### Production of an Isocyanato Acrylate

9000 g 4,4′-(2,4′-)diisocyanatodicyclohexylmethane were submitted under nitrogen in a plane-ground vessel with stirrer, reflux condenser, nitrogen delivery line, internal thermometer and dropping funnel. Subsequently heating was effected to 60° C., and 28.0 g of a 5% solution of trimethylbenzylammonium hydroxide, dissolved in n-butanol/methanol=12:1, were added slowly in metered amounts, the temperature being maintained between 60° C. and 80° C. for such time, until the NCO content of the raw solution was between 25.5% and 25.8%. Subsequently 21.0 g of a 5% solution of dibutyl phosphate in 4,4′-(2,4′-)diisocyanatodicyclohexylmethane were added, cooled and added to 450 g of a commercial isocyanurate polyisocyanate based on diisocyanatohexane (HDI) (NCO=21.8%, viscosity=3000 mPas/23° C., monomeric HDI=0.1%), and at 200° C./ 0. 15 mbar monomeric 4,4′-(2,4′-)diisocyanatodicyclohexylmethane was separated off by thin-layer distillation. 1894.52 g of the solid resin obtained in this way (NCO=15.0%) were withdrawn and submitted in a further multinecked flask with reflux condenser, dropping funnel, internal thermometer, stirrer and air-conveying line (6 l/h) together with 975.00 g butyl acetate, 3.176 g dibutyltin dilaurate and 3.18 g 2,6-di-tert.butyl-4-methylphenol and, with stirring, were heated up to 60° C. 374.12 g hydroxyethyl acrylate were subsequently added slowly dropwise, whereby a maximal temperature of 65° C. was attained. After this, the reaction mixture was stirred at 60° C. until such time as an NCO content ≦4.4% was obtained.

Characteristics after storage for 24 h at RT:

| | | | | Colour Index |
|---|---|---|---|---|
| | Viscosity | Solids Content | NCO Content | (APHA) |
| Example 1 | 7200 mPas | 75.3% | 4.2% | 22 |

### Example 2

### Production of an Epoxy Acrylate

In a multinecked flask with distillation bridge, stirrer and nitrogen-conveying line (6 l/h) 2700.06 g adipic acid and 499.54 g butanediol were submitted at room temperature and, with stirring, were heated to 180° C. until an acid value of ≦484 was obtained. 2251.88 g of this initial product were submitted in a further multinecked flask with reflux condenser, internal thermometer and air-conveying line (6 l/h) together with 2735.94 g glycidyl methacrylate, 9.98 g triphenylphosphine and 4.99 g 2,6-di-tert.butyl-4-methylphenol at RT and were slowly heated up to 80° C., with stirring, and maintained at this temperature until such time as the acid value was constant ≦20.

Characteristics after storage for 24 h at RT:

| | | | | Colour Index |
|---|---|---|---|---|
| | Viscosity | Hydroxyl Value | Acid Value | (APHA) |
| Example 2 | 2900 mPas | 216 | 20.5 | 114 |

### Example 3

### Production of a Polycarbonate Diol Based on 3-methyl-1,5-pentanediol

In a 60 l pressurized reactor with distilling head, stirrer and receiver, 34 092 g 3-methyl-1,5-pentanediol were submitted with 8.0 g ytterbium(III) acetylacetonate and also 10 223 g dimethyl carbonate at 80° C. Subsequently, under nitrogen atmosphere the reaction mixture was heated up in 2 h to 150° C. and maintained at this temperature, with stirring and reflux, for 2 h, whereby the pressure rose to 3.9 bar (absolute). After this, the cleavage product methanol in the mixture with dimethyl carbonate was removed by distillation, whereby the pressure was lowered continuously within 4 h by a total of 2.2 bar. Subsequently the distillation process was concluded, and a further 10 223 g dimethyl carbonate at 150° C. were pumped into the reaction mixture and maintained there, with stirring and reflux, for 2 h, whereby the pressure rose to 3.9 bar (absolute). After this, the cleavage product methanol in the mixture with dimethyl carbonate was again removed by distillation, whereby the pressure was lowered continuously within 4 h by a total of 2.2 bar. Subsequently the distillation process was concluded, and a further 7147 g dimethyl carbonate at 150° C. were pumped into the reaction mixture and maintained at this temperature, with stirring and reflux, for 2 h, whereby the pressure rose to 3.5 bar (absolute). After this, the cleavage product methanol in the mixture with dimethyl carbonate was again removed by distillation, whereby the pressure was lowered continuously within 4 h to normal pressure. Subsequent to this, the reaction mixture was heated within 2 h to 180° C. and maintained at this temperature for 2 h, with stirring. Subsequent to this, the temperature was reduced to 130° C., and a stream of nitrogen (5 l/h) was passed through the reaction mixture, while the pressure was lowered to 20 mbar. After this, the temperature was raised to 180° C. within 4 h and maintained there for 6 h. In the process, the further removal of methanol in the mixture with dimethyl carbonate from the reaction mixture was effected.

After aeration and cooling of the reaction charge to room temperature, a colorless, liquid oligocarbonate diol was obtained having the following characteristics:

| | | Hydroxyl | Number-Average |
|---|---|---|---|
| | Viscosity | Value | Molecular Weight Mₙ |
| Example 3 | 175 mPas with D 16 l/s⁻¹ | 173 | 650 |

### Example 4

### Production of a UV-Curing Polyurethane Dispersion

In a reaction vessel with stirrer, internal thermometer and gas feed (air stream 1 l/h), 210.3 g of the hydroxy-functional polyester acrylate Laromer® PE44F (BASF AG, Ludwigshafen, DE), 701.3 g of the C4 polyether Terathane® 2000 (Invista, Wichita, US), 43.6 g dimethylolpropionic acid, 0.7 g dibutyltin dilaurate, 390.0 g acetone were submitted, added to a mixture of 157.0 g Desmodur® W (cycloaliphatic diisocyanate; Bayer MaterialScience AG, Leverkusen, DE) and 80.3 g Desmodur® H (aliphatic diisocyanate; Bayer-MaterialScience AG, Leverkusen, DE) and heated up in such a manner that a constant reflux of acetone prevailed. Stirring was effected at this temperature until such time as the reaction mixture contained an NCO content of 1.6±0.1 wt. %.

Then cooling was effected to 40° C., and 33.6 g ethyldiisopropylamine were added. After stirring for 5 min at 40° C., the reaction mixture was poured, with rapid stirring, into 2250 g water at 20° C. Subsequently 42.6 g isophoronediamine in 125.0 g water were added. After further stirring for 30 min without heating or cooling, the product was distilled in a vacuum (50 mbar, max. 50° C.) until a solids content of 35±1 wt. % was obtained. The dispersion has a pH value of 8.3 and an average particle size of 100 nm (measurement by laser correlation spectroscopy: Zetasizer 1000, Malvern Instruments, Malvern, UK). Outflow time in a 4 mm beaker: 18 s.

### Example 5

### Formulation of a Solvent-Containing Dual-Cure Screen-Printing Ink

By way of component A), 68.7 g of the isocyanato acrylate from Example 1 and 4.0 g of the isocyanato acrylate Desmolux® XP 2510 (90% in butyl acetate, NCO content 7.0%, molecular weight Mn about 1200 g/mol, viscosity 15,000 mPas, D 40 l/s, 23° C.; Bayer MaterialScience AG, Leverkusen, DE) were mixed. By way of component B), 11.0 g of the carbonate diol from Example 3, 8.9 g of the epoxy acrylate from Example 2, 6.4 g of a 50% solution of the photoinitiator Igracure® 184 (Ciba Speciality Chemicals, Basel, CH) in butyl acetate, 0.7 g flow-control and wetting additive Byk® 306 (Byk-Chemie, Wesel, DE) and 0.3 g dibutyltin dilaurate were mixed homogeneously with one another. The components A) and B) were mixed with one another immediately prior to printing, in a ratio of 1:1. For the purpose of adapting the viscosity, 28 parts butyl acetate were added to 100 parts of the mixture.

### Example 6

### Formulation of an Aqueous Physically Drying and UV-Curing Screen-Printing Ink

Under a dissolver, 95.3 g of the dispersion from Example 4 were dispersed with 2.0 g Acematt® 3200 and 2.0 g Acematt® 3300 (flatting agent, Degussa, Düsseldorf, DE) for 5 min at 2000 rpm. Subsequently the following were worked in successively at 500 rpm: 0.3 g Igracure® 500 (photoinitiator, Ciba Speciality Chemicals, Basel, CH), 0.2 g Dehydran 1293 (defoamer, Cognis GmbH & Co KG, Düsseldorf, DE), 0.2 g Byk® 348 (flow-control and wetting additive, Byk-Chemie, Wesel, DE). After addition of each additive, stirring was effected in each instance for 5 min.

### Example 7

### Production of Printed and Molded Films

### Production of Printed Films of Synthetic Material

ABS and PC plastic films (Bayfol® DFA and Makrofol® DE1-1) in the form of sheet goods (both left untreated and printed with a physically drying, silver-metallic screen-printing ink Noriphan® HTR [Pröll K G, Weiβenburg, DE] in the screen-printing process and dried, in accordance with the manufacturer's specifications) were coated in the screen-printing process with the printing-inks according to Examples 6 and 7, with the following print parameters:

Semiautomatic screen-printing machine; manufacturer ESC (Europa Siebdruck Centrum); woven fabric 80 THT polyester; RKS blade; dry-film layer thickness: 10-12 μm.

### Predrying/Precrosslinking

Some of the coated sheets of synthetic material were predried for 30 minutes in a chamber furnace at 80° C. The remainder of the sheets were predried by means of continuous furnaces (hot air/IR flat channel [manufacturer SPS, Wuppertal] at a speed of 3 m/min [film temperature 85° C.]). All the films were subsequently touch-dry and non-blocking.

Thermoforming

| | |
|---|---|
| Thermoforming unit: | Adolf ILLIG, Heilbronn |
| Tool temperature: | 60° C. with Bayfol DFA, or 100° C. with |
| | Makrofol ® DE1-1 |
| Film temperature: | 165° C. with Bayfol ® DFA, or 190° C. |
| | with Makrofol ® DE1-1 |
| Heating-time: | 15 s with Bayfol DFA, or 20 s with |
| | Makrofol ® DE1-1 |
| Tool: | heating/ventilating aperture for producing |
| | films for the interior finishing of automobiles |

High-pressure molding process

| | |
|---|---|
| HPF unit: | HDVF Penzberg, plastics machines (type: SAMK 360) |
| Tool temperature: | Bayfol ® DFA 100° C., Makrofol ® DE1-1 100° C. |
| Film temperature: | Bayfol ® DFA 130° C., Makrofol ® DE1-1 140° C. |
| Heating-time: | Bayfol ® DFA 10 s, Makrofol ® DE1-1 14 s |
| Pressure: | 100 bar |
| Tool: | heating/ventilating aperture for producing films for the |
| | interior finishing of automobiles |

UV curing of the molded, printed films:

| | |
|---|---|
| UV unit: | IST-UV channel |
| Lamp type: | mercury CM radiation source 80 W/cm |
| UV dose: | 4 passes × 500 mJ/cm² |
| Rate of curing: | 5 m/min |

### Example 8

### Production of Moldings

Injection-backing of the ABS films:
The three-dimensional, UV-cured films were injection-backed as follows:

| | |
|---|---|
| Unit type: | ARBURG 570C, Loβburg (type: Allrounder |
| | 2000-675) |
| Injecting temperature: | 260° C. melt |
| Tool temperature: | 60° C. |
| Injection pressure: | 1400 bar |
| Injection-backing material: | Bayblend ® T65 (amorphous, thermoplastic |
| | polymer blend based on polycarbonate |
| | and ABS; Bayer MaterialScience AG, |
| | Leverkusen, DE) |
| Filling-time: | 2 s |

### Testing of the Surfaces of the Molded Films and of the Moldings

Substrate: Bayfol® DFA printed silver-metallic with Noriphan HTR, production according to Example 7; by way of reference, the films printed only with Noriphan® HTR were produced in a manner analogous to Example 7 but without UV curing.

| | | Printed with | Printed with |
|---|---|---|---|
| | | screen-printing | screen-printing |
| | | ink as in | ink as in |
| | | Example 5 | Example 6 |
| | | (according to | (according to the |
| | | the invention) | invention) |
| Solvent resistance | Clear | No change | No change |
| loading for 2 min at | irreversible | | |
| 23° C. with a cotton | change in the | | |
| swab saturated with | surface | | |
| ethyl acetate) | | | |
| Solvent resistance | Clear | No change | Change in the |
| (loading for 2 min | irreversible | | surface, after |
| at 23° C. with a | change in the | | recovery (30 min |
| cotton swab | surface | | RT) only slight |
| saturated with | | | shadow visible |
| acetone) | | | |
| Abrasion | 70 cycles | >500 cycles | 120 cycles |
| resistance (Taber | | | |
| abraser CS10F, | | | |
| rubbing through | | | |
| after cycles, result | | | |
| normalized to | | | |
| 10 μm dry-film | | | |
| layer) | | | |
| Scratch resistance | 10 | 120 | 40 |
| (number of double | | | |
| strokes with steel | | | |
| wool, type 0/0/0/0, | | | |
| 800 g burden until | | | |
| coating rubbed | | | |
| through) | | | |

The test results show clearly that by means of the process according to the invention surfaces on molded films can be obtained having better stabilities, abrasion resistances and scratch resistances than in accordance with the processes of the state of the art.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for producing singly or multiply printed molded films, comprising
A) optionally printing a thermoplastic film with one or more color-imparting coating agents a) and subsequently drying and/or curing the coating agents a) to yield a coating a*), the coating agent a) and the drying/curing conditions being chosen such that the coating a*) is thermoplastic,
B) printing the thermoplastic film with at least one coating agent b) which contains constituents that are capable of being cured with actinic radiation,
C) drying and/or curing the coating agent b), without exposing the coating agent b) to actinic radiation, to yield a non-blocking and thermoplastic coating b*),
D) molding the coated thermoplastic film at an elevated temperature,
E) curing the coating b*) by irradiation with actinic radiation to yield a thermosetting layer, and
F) optionally backing the coated film with synthetic materials.

2. Process according to claim 1, wherein in step B) the coating agent b) is applied with the aid of a screen-printing process.

3. Process according to claim 1, wherein in step D) the deformation is implemented under the influence of pressure of at least 20 bar.

4. Process according to claim 3, wherein in step D) the deformation is implemented at a temperature below the glass-transition temperature of the film.

5. Process according to claim 1, wherein in step F) the film is injection-backed with thermoplastic synthetic materials.

6. Process according to claim 1, wherein in step F) the film is foam-backed with single component synthetic materials.

7. Process according to claim 1, wherein in step F) the film is foam-backed with multi-component synthetic materials.

8. A molded film produced in accordance with claim 1.

9. A molded film according to claim 5, wherein on the non-printed side is connected to at least one filled polymer.

10. A molded film according to claim 6, wherein the filled polymer is selected from the group consisting of thermoplastics, reactive single-component polymers and reactive multi-component polymers.

11. A molded film according to claim 6, wherein the at least one filled polymer is connected by injection-backing.

12. A molded film according to claim 6, wherein the at least one filled polymer is connected or foam-backing.
